(19) United States
(12) Patent Application Publication
(10) Pub. No.: US 2020/0019202 A1
(43) Pub. Date: Jan. 16, 2020

(54) CURRENT SOURCE CIRCUIT

(71) Applicant: TEXAS INSTRUMENTS INCORPORATED, Dallas, TX (US)

(72) Inventors: Divya KAUR, Delhi (IN); Rajat CHAUHAN, Bengaluru (IN); Santhosh Kumar SRINIVASAN, Bengaluru (IN)

(21) Appl. No.: 16/202,753

(22) Filed: Nov. 28, 2018

(30) Foreign Application Priority Data
Jul. 12, 2018 (IN) 201841026038

(51) Int. Cl. G05F 3/26

(52) U.S. Cl. CPC G05F 3/262

(57) ABSTRACT

A current source circuit includes an initial bias generator and a diode-connected first metal oxide semiconductor (MOS) transistor having a gate, a source, and a drain. The drain of the diode-connected MOS transistor is connected to the initial bias generator. The current source circuit also includes a second MOS transistor, a first resistor, and a current mirror. The second MOS transistor has a gate connected to the gate and drain of the diode-connected first MOS transistor. The first resistor is coupled between a source of the second MOS transistor and a ground node. The current mirror is coupled to a drain of the second MOS transistor and generates bias current for other components within the current source circuit.

### CROSS-REFERENCE TO RELATED APPLICATIONS

The present application claims priority to India Provisional Patent Application No. 201841026038, filed Jul. 12, 2018, entitled “A NA IQ, Fast Response, Low Area Current Reference,” which is hereby incorporated herein by reference in its entirety.

### BACKGROUND

Current source circuits are prevalent in many applications. Current sources generally provide a regulated amount of current to other circuits in a system. In some applications, current sources provide current bias to other circuits at power-up of the system. In some applications, the speed at which the current source is able to start producing the regulated current level following a power cycle event is a design parameter of the system. Further, sudden variations in the supply voltage may cause the regulated current produced by the current source to change. The amount of time at which the current source is able to recover back to its regulated current level may be a consideration in the system's performance.

### SUMMARY

In one example, a current source circuit includes a current source sub-circuit and a diode-connected first metal oxide semiconductor (MOS) transistor having a gate, a source, and a drain. The drain of the diode-connected MOS transistor is connected to the current source sub-circuit. The current source circuit also includes a second MOS transistor, a first resistor, and a current mirror. The second MOS transistor has a gate connected to the gate and drain of the diode-connected first MOS transistor. The first resistor is coupled between a source of the second MOS transistor and a ground node. The current mirror is coupled to a drain of the second MOS transistor.

### BRIEF DESCRIPTION OF THE DRAWINGS

For a detailed description of various examples, reference will now be made to the accompanying drawings in which:

FIGS. 1A-1D show examples of current source circuits.

FIG. 2 illustrates another example of a current source circuit.

FIG. 3 illustrates how the current source circuit can be tuned such that the bias current produced by the current source circuit is directly related to temperature.

FIG. 4 shows waveforms of the current source circuit of FIG. 2 illustrating its transient response when tuned such that the bias current is directly related to temperature.

FIG. 5 illustrates how the current source circuit can be tuned such that the bias current produced by the current source circuit does not vary, or varies very little, with respect to temperature.

FIG. 6 shows waveforms of the current source circuit of FIG. 2 illustrating its transient response when tuned such that the bias current does not vary with temperature.

FIG. 7 illustrates how the current source circuit can be tuned such that the bias current produced by the current source circuit is inversely related to temperature.

FIG. 8 shows waveforms of the current source circuit of FIG. 2 illustrating its transient response when tuned such that the bias current varies inversely with temperature.

FIG. 9 illustrates another example of a current source circuit.

FIG. 10 illustrates the start-up and supply voltage transient response of the currents sources of FIGS. 2 and 9.

FIG. 11 illustrates a system which includes the described current source circuit.

### DETAILED DESCRIPTION

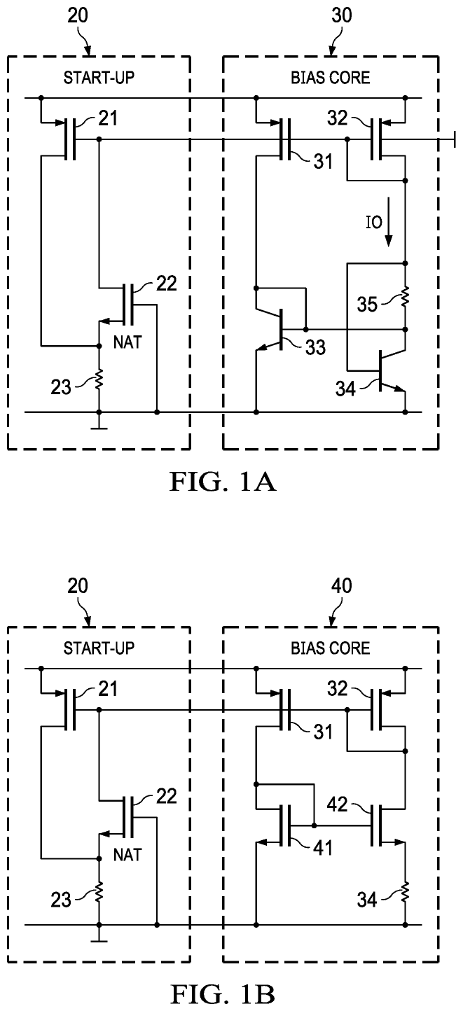

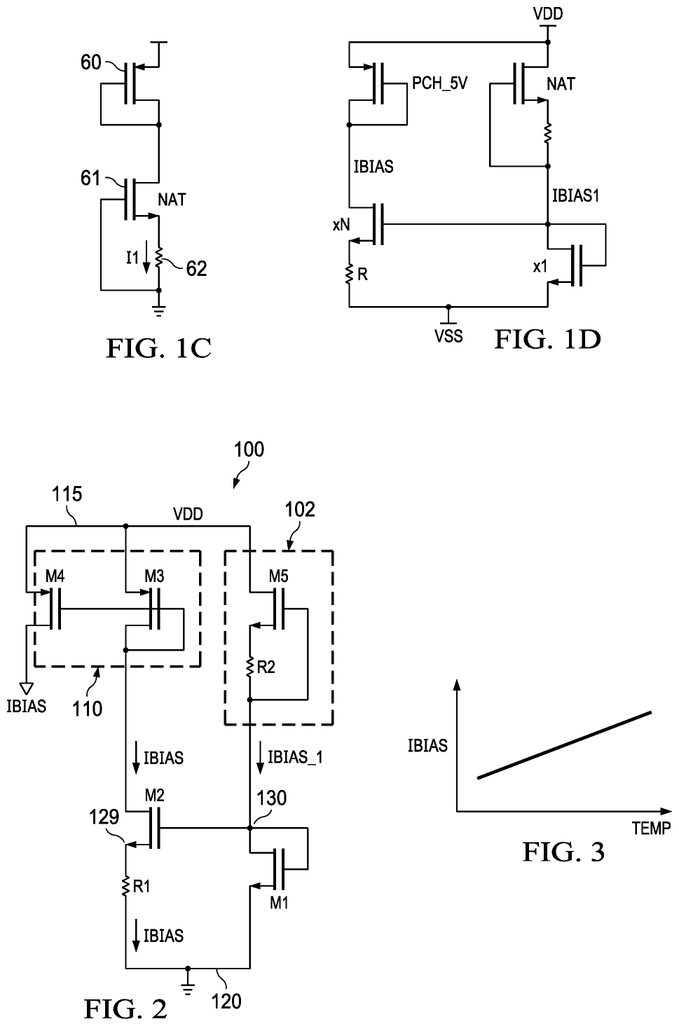

FIGS. 1A-1D show examples of current source circuits. The current source circuit of FIG. 1A includes a startup circuit 20 and a bias core circuit 30. The start-up circuit 20 includes transistors 21 and 22 coupled to a resistor 23. The bias core circuit 30 includes transistors 31, 32, 33, 34 and resistor 35. Transistors 33 and 34 comprise bipolar junction transistors. The start-up circuit 20 ensures that a non-zero current is generated by the bias core circuit 30 at startup of the current source circuit. Without the start-up circuit 20, the bias core circuit may be forced to operate with zero current as current Io. Zero operating current is a valid operating point for the current source circuit of FIG. 1A, but the circuit may be stuck at an Io current of zero. However, the gate of transistor is pulled low by transistor 22 turning on at very low voltages. With the gate of transistor 21 pulled low, the gate of transistor 31 also is pulled low thereby turning on transistor 31. Because transistor 31 is connected to transistor 32 in a current mirror configuration, non-zero current Io begins to flow. Resistor 35 is generally a relatively large resistor (e.g., greater than 100 mega-ohms) for an Io in the nano-ampere range. Resistor 35 thus requires considerable area. Further, the start-up time of the current source circuit of FIG. 1A is relatively large, as is the recovery time from fast line transients of its supply voltage, due to a relatively large resistor 35 and large parasitic capacitance introduced by bipolar junction transistors 33 and 34.

FIG. 1B shows an example similar to that of FIG. 1A, but with the bipolar junction transistors 33 and 34 of FIG. 1A replaced with metal oxide semiconductor field effect (MOS) transistors 41 and 42 in FIG. 1B. As was the case of FIG. 1A, a startup circuit 20 is required, a relatively large resistor 34 is also required, and the current source circuit of FIG. 1B also is characterized by a relatively long start-up time and a relatively long recovery time from supply voltage transients.

FIG. 1C shows a current source circuit comprising a transistor 60 connected to a transistor 61, which in turn is connected to a resistor 62. Transistor 61 in this example is a natural transistor (a transistor having a negative or approximately zero threshold voltage). The current I1 produced by this current source is the threshold voltage of transistor 61 divided by the resistance of resistor 62. Resistor 62 need not be as large in this example as for the circuits of FIGS. 1A and 1B. Further, a startup circuit is not needed. However, the current source circuit suffers from a relatively poor current accuracy, meaning that the current I1 varies substantially with process and temperature.

FIG. 1D shows another current source circuit. As was the case for the circuit of FIG. 1C, the current source circuit in FIG. 1D does not require a startup circuit, but its accuracy is not very good and its operation is sensitive to variations in the supply voltage.

Examples of a current source are described herein. The described current sources are characterized by one or more of the following features. In some cases, the described current sources are capable of a relatively rapid start-up (e.g., less than 50 microseconds with a supply voltage ramp-up of 1 V per microsecond) without the use of start-up circuit. Further, the disclosed current sources are capable of relatively fast recovery of their reference current from a sudden variation of the supply voltage. Further still, the temperature dependence on the reference current produced by the current source can be controlled through selection of the relative sizes of multiple transistors within the current source.

FIG. 2 shows an example of a current source circuit 100. In this example, current source circuit 100 includes an initial bias current generator 102, a diode-connected transistor M1, transistor M2, a resistor R1, and a current mirror 110. The initial bias current generator 102 comprises a metal oxide semiconductor (MOS) transistor M5 coupled to a resistor R2 in a degenerate configuration. The drain of M5 is connected to a supply voltage node 115 (VDD), and the source of M5 is connected to one terminal of R2. The gate of M5 is connected to the other terminal of R2, as shown. The current source sub-circuit 102 (and in the example of FIG. 2, the resistor R2) connects to the drain of M1 at node 130. The gate of M1 is also connected to its drain at node 130, thereby configuring M1 as a diode-connected transistor. The source of M1 is connected to the other supply voltage node 120 (ground in this example, also referred to as ground node 120).

In the example of FIG. 2, the gate of transistor M2 connects to node 130 and thus to the gate and drain of M1. Resistor R1 is coupled between the source of M2 at node 129 and ground node 120. The current mirror 110 includes multiple transistors—two transistors in this example, transistors M3 and M4. The gates of M3 and M4 are connected together and to the drain of M3 as well. The drain of M3 is connected to the drain of M2. The sources of M3 and M4 are connected to the supply voltage node 115. The current source circuit 100 generates a relatively constant reference current referred herein as IBIAS from the drain of M4.

In operation, current source sub-circuit 102 generates a bias current, generally smaller than IBIAS, that is shown in FIG. 2 as IBIAS_1. The IBIAS_1 current flows into the diode-connected transistor M1 and causes a voltage to be generated on node 130 and is provided to the gate of M2. The voltage generated on node 130 by the diode-connected transistor M1 is generated as a result of the initial bias generator 102 generating IBIAS_1 current at relatively low levels of VDD as VDD is ramping up during a power-on event. As such, the initial bias generator 102 causes the diode-connected transistor M1 to generate a bias voltage for the gate of M2 early on during a power-on event to thereby begin the flow of IBIAS current through M2. As IBIAS_1 is relatively small, the resistor R2 is relatively small as well, which helps to reduce the size of the circuit.

The current that is caused to flow through resistor R1 is IBIAS and is the difference in gate-to-source voltages (VGS) of M1 and M2 divided by the resistance of R1, that is,

$$IBIAS = \frac{VGS\_M1 - VGS\_M2}{R 1} \qquad ( 1 )$$

The same bias current IBIAS also flows from VDD through M3 of the current mirror 110. As the gates of M3 and M4 are connected together (as are the sources of M3 and M4), the VGS is the same for M3 and M4 and thus IBIAS also flows through M4.

In the example of FIG. 2, M1, M2, and M5 comprise n-channel MOS (NMOS) transistors and M3 and M4 comprise p-channel MOS (PMOS) transistors. In some implementations, M5 comprises a natural NMOS transistor (also referred to as a native transistor). A natural transistor is a transistor having a negative or approximately zero threshold voltage. The threshold voltage of a transistor can be set by adding implants during the manufacturing process. For example, to increase the threshold voltage of an NMOS transistor, p-type implants are added. Depending on the type and amount of implant added, a particular threshold voltage can be achieved. In one example, the threshold for an NMOS natural transistor is between −150 mV and 0 V or slightly positive. The IBIAS_1 current generated by M5 through R2 generally is not highly regulated as it is a function of the threshold voltage of M5 which varies, but IBIAS_1 is useful to provide the initial bias current thereby making the current source circuit 100 self-starting.

The diode-connected transistor M1 can be implemented as a Normal Standard Threshold Voltage (SVT) transistor or as a low threshold voltage (LVT) NMOS transistor. An example of the threshold voltage for an SVT NMOS transistor is between 0.4V and 0.8V. An LVT transistor is a transistor that has a threshold voltage that is less than the threshold voltage of an SVT transistor. An example of the threshold voltage for an LVT NMOS transistor is between 0.3V and 0.5V. Further, M2 can be implemented as a natural transistor, a depletion mode transistor or an LVT transistor as long as the threshold voltage of M1 is higher than threshold voltage of M2. For example, M1 and M2 may be implemented as:
M1 is an SVT NMOS transistor and M2 is a natural NMOS transistor
M1 is an SVT NMOS transistor and M2 is a depletion mode NMOS transistor
M1 is an SVT NMOS transistor and M2 is an LVT NMOS transistor
M1 is an LVT NMOS transistor and M2 is a natural NMOS transistor
M1 is an LVT NMOS transistor and M2 is a depletion mode NMOS transistor

M3 and M4 of the current mirror 110 are PMOS transistors in the example of FIG. 1 and, in some implementations, comprise SVT/LVT PMOS transistors. Implementing M3 and M4 are LVT transistors provides additional headroom so that the current source circuit 100 can operate with a lower VDD.

The current that is caused to flow through resistor R1 is IBIAS. IBIAS is calculated as the voltage across R1 divided by the resistance of R1. The voltage across R1 is the gate-to-source voltage across M1 plus the gate-to-source voltage across M2. Transistors M1 and M2 operate in the subthreshold region in which the drain current (Id) is exponentially related to the drain-to-source voltage (VDS). The expression for IBIAS can be derived as:

$$IBIAS = \frac{n * VT * ln ( \frac{IBIAS\_ 1}{IBIAS} * \frac{β eff\_M2}{β eff\_M1} ) + ( VTH\_M1 - VTH\_M2 )}{R 1} \qquad ( 2 )$$

where:
n is the sub-threshold slope factor of M2, which is given as

$$n = \frac{Cox + Cdep}{Cox} = 1 + Cdep / Cox ,$$

where Cdep is the depletion layer capacitance and Cox is the oxide capacitance per unit area of M2,
In refers to the natural logarithm function,
VT is thermal voltage defined by kT/q for which k is Boltzmann's constant, T is temperature and q is the electronic charge,
βeff_M2 is the beta of the transistor M2 using the actual width and length of the transistor in operation (not their “drawn” values) and equals, as a first approximation,

$${μ}_{eff} {C}_{ox} ( \frac{{W}_{eff}}{{L}_{eff}} )$$

where μ_{eff} is the effective mobility for M2, Cₒₓ is the gate oxide capacitance per unit area of M2, Weff and Leff are the effective width and length of M2's channel (after accounting for the effects of bias dependencies on the width and the length of the channel),
βeff_M1 is the effective beta of transistor M1 using the effective width and length of M1 and the effective mobility of M2.
VTH_M1 is the threshold voltage for M1, and
VTH_M2 is the threshold voltage for M2

The right-hand term in the numerator of Eq. (2), VTH_M1−VTH_M2, varies with temperature and can vary inversely or directly depending on the combination of choices of transistors M1 and M2. As such, the there is a dependence of IBIAS on the threshold voltage difference between transistors M1 and M2. Transistors M1 and M2 are correlated in some implementations as they are fabricated from the same process. The correlation of transistors M1 and M2 provide for a predictable temperature dependence on IBIAS which helps to improve the accuracy of IBIAS over process variations. The left-hand term in the numerator of Eq. (2) is

$$n * VT * ln ( \frac{IBIAS\_ 1}{IBIAS} * \frac{β eff\_M2}{β eff\_M1} ) \cdot VT$$

is related to temperature as VT=kT/q, and thus VT is proportional to temperature. The argument of the natural logarithm in Eq. (2) includes

$$\frac{β eff\_M2}{β eff\_M1} ,$$

and each effective beta is a function of the ratio of width (W) to length (L) of its respective transistor. The natural logarithm of a number is positive if the number is greater than 1. The natural logarithm of a number is negative if the number is less than 1, and 0 if the number equals 1. Thus, the left-hand term of the numerator in Eq. (2) will be 0 if the argument of the natural logarithm is 1, a positive value if the argument of the natural logarithm is greater than 1, or a negative value if the argument of the natural logarithm is less than 1.

The argument of the natural logarithm in Eq. (2) can be controlled by controlling the ratios of the effective betas of M2 and M2. The effective beta of each of M2 and M1 is a function of the ratio of width to length of that transistor's channel and the mobility. As such, the argument of the natural logarithm of Eq. (2) is determined, at least in part, by the relative sizes of M1 and M2. The argument of the natural logarithm will be:
Greater than 1 if M1 and M2 are sized such that the ratios of the effective betas, when multiplied by the ratio of IBIAS_1 to IBIAS is greater than 1,
Less than 1 if M1 and M2 are sized such that the ratios of the effective betas, when multiplied by the ratio of IBIAS_1 to IBIAS is less than 1, and
Equal to 1 if M1 and M2 are sized such that the ratios of the effective betas, when multiplied by the ratio of IBIAS_1 to IBIAS is equal to 1
   For example, if IBIAS_1 is one-tenth of IBIAS, then the argument of the natural logarithm will be greater than 1 if the ratio of the effective betas is greater than 10.

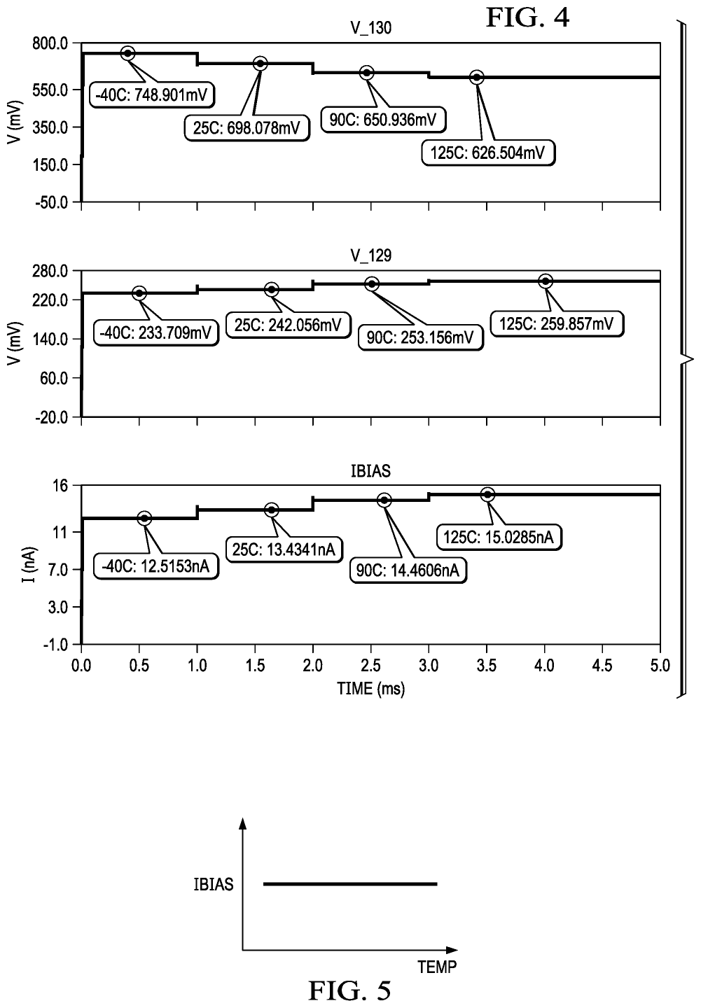

Some applications in which a current source is used may benefit from the current's sources IBIAS current being directly proportional to temperature. FIG. 3 illustrates a direct relationship of IBIAS with respect to temperature. If the right-hand term in the numerator of Eq. (2) is proportional to temperature, then the left-hand term in the numerator should be greater than 0 (i.e., not negative). This result can be accomplished, for example, by setting the relative W/L ratios of M1 and M2 such that the argument of the natural logarithm of Eq. (2) is 1 or greater than 1. If the right-hand term in the numerator of Eq. (2) is inversely proportional to temperature, then the left-hand term in the numerator should be greater than 1 and large enough so as to counteract the inverse temperature dependence of the right-hand term. This result can be accomplished, for example, by setting the relative W/L ratios of M1 and M2 such that the argument of the natural logarithm of Eq. (2) is substantially greater than 1. FIG. 4 illustrates the transient response of the current source circuit 100 of FIG. 2 for its bias current IBIAS to be directly proportional to temperature. FIG. 4 illustrates the transient response of the voltage on node 130 (“V_130”), the voltage on node 129 (“V_129), and IBIAS for a step increase in temperature from −40 degrees centigrade to 25 degrees centigrade to 90 degrees centigrade to 125 degrees centigrade.

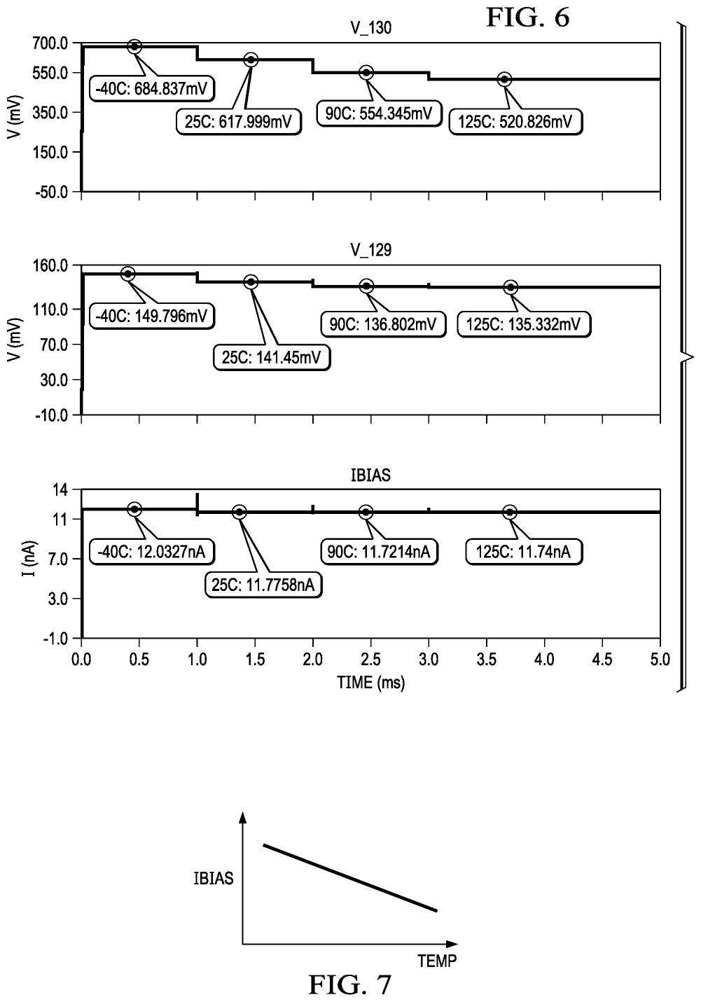

With reference to FIGS. 2 and 4, the threshold voltages of M1 and M2 both have negative temperature coefficients (which is typical of MOSFETs) and thus the difference between the threshold voltages of M1 and M2 varies relatively little with temperature. As temperature increases, the threshold voltage of M1 reduces and thus the drain-to-source voltage across M1 (voltage on node 130) decreases as shown in the top waveform in FIG. 6. The threshold voltage of M2 also decreases with an increase in temperature and thus M2's drain-to-source voltage also decreases. The decrease in the threshold voltage of M2 thus manifests itself as an increase in the voltage on its source (V_129) as shown in the middle waveform of FIG. 4. With V_129 increasing, the current through M2 (IBIAS) increases as shown in the bottom waveform of FIG. 4. Other applications in which a current source is used may benefit from the current source's IBIAS current being invariant with respect to temperature (e.g., FIG. 5). As explained above, the right-hand term in the numerator of Eq. (2) (i.e., VTH_M1−VTH_M2) may vary directly or inversely with temperature. To achieve approximate temperature invariance for IBIAS, the left-hand term in the numerator of Eq. (2) should have a temperature variance that varies opposite to that of the right-hand term. For example, if the right-hand term varies directly with temperature, the W/L ratios of M1 and M2 should be set such that the argument of the natural logarithm of Eq. (2) is less than 1 and at a value that counteracts the temperature dependence of the right-hand term. Similarly, if the right-hand term inversely varies with temperature, the W/L ratios of M1 and M2 should be set such that the argument of the natural logarithm of Eq. (2) is greater than 1 and again at a value that counteracts the temperature dependence of the right-hand term.

FIG. 5 illustrates an example in which IBIAS does not vary, or varies very little, with respect to temperature, and FIG. 6 illustrates the corresponding transient behavior for V_130, V_129, and IBIAS. As noted above, the threshold voltages of M1 and M2 have negative temperature coefficients and thus the difference between the threshold voltages of M1 and M2 varies relatively little with temperature. If temperature were, for example, to increase, the threshold voltage of M1 reduces and thus the drain-to-source voltage across M1 (voltage node 130) decreases as shown in the top waveform in FIG. 6. Consequently, the gate-to-source voltage across M2 decreases. The difference in the gate-to-source voltages of M1 and M2 varies inversely with temperature, but does not vary greatly. Through component value selection and design, the ratio of the voltage across R1 and the resistance value of R1 can be forced to not vary by much with temperature.

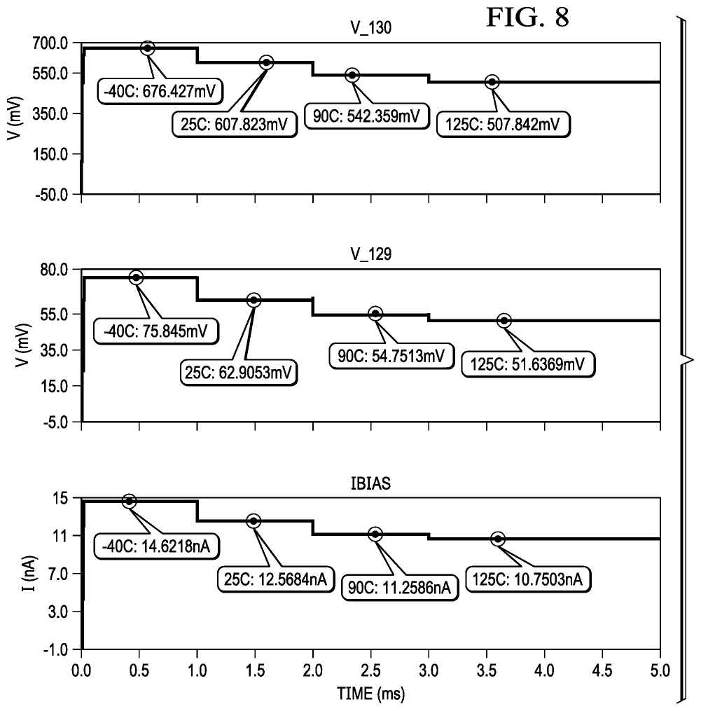

Yet other applications in which a current source is used may benefit from the current sources' IBIAS current being inversely related to temperature. FIG. 7 illustrates an inverse relationship of IBIAS with respect to temperature, and FIG. 8 shows the corresponding transient response. This result can be accomplished by setting the relative W/L ratios of M1 and M2 based on the temperature dependence of the right-hand term. For example, if the right-hand term varies inversely with temperature, the W/L ratios of M1 and M2 should be set such that either (a) the argument of the natural logarithm of Eq. (2) is approximately 1 so that the left-hand term of the numerator of Eq. (2) is approximately 0 thereby permitting the temperature relationship of the right-hand term to dominate or (b) the argument of the natural logarithm of Eq. (2) is less than 1 thereby further reinforcing the inverse temperature relationship of the right-hand term. As temperature decreases, the threshold voltage of M1 reduces and thus the drain-to-source voltage across M1 (voltage node 130) decreases as shown in the top waveform for V_130. Consequently, the gate voltage of M2 decreases. The voltage on node 129 (V_129) decreases and thus IBIAS decreases as well as shown in the bottom waveform.

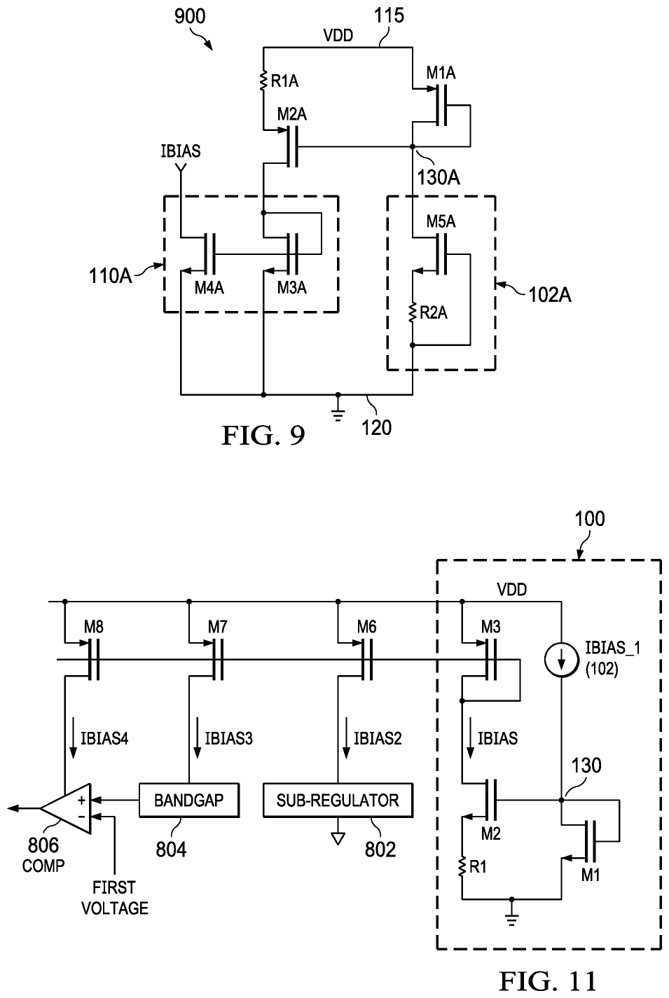

FIG. 9 shows an implementation of a current source circuit 500, similar to that of FIG. 1, but with oppositely doped transistors. That is, where the current source circuit 100 of FIG. 1 used NMOS transistors, the current source circuit 500 of FIG. 9 uses PMOS transistors and where current source circuit 100 used PMOS transistors, current source circuit 500 uses NMOS transistors.

In the example of FIG. 9, current source circuit 500 includes an initial bias generator 102A, a diode-connected transistor M1A, transistor M2A, a resistor R1A, and a current mirror 110A. The initial bias generator 102A comprises an NMOS transistor M5A coupled to a resistor R2A in a degenerate configuration. The initial bias generator 102A connects to the drain of M1A at node 130A. The gate of M1A is also connected to its drain at node 130A, thereby configuring M1A as a diode-connected transistor. The source of M1A is connected to the supply voltage node 115 (VDD). The gate of transistor M2A connects to node 130A and thus to the gate and drain of M1A. Resistor R1A is coupled between the source of M2A and the supply node 115. The current mirror 110A includes transistors M3A and M4A. The gates of M3A and M4A are connected together and to the drain of M3A as well. The drain of M3A is connected to the drain of M2A. The sources of M3A and M4A are connected to the ground node 120. The current source circuit 500 generates IBIAS into the drain of M4A. The operation of current source circuit 500 is similar to that described above regarding current source circuit 100.

In the example of FIG. 9, M1A and M2A comprise PMOS transistors and M3A, M4A, and M5A comprise NMOS transistors. Various combinations of transistor types are possible for M1A and M2A as was the case for M1 and M2 in FIG. 1. For example, M1A and M2A can comprise:
M1A is an SVT PMOS transistor and M2A is a natural PMOS transistor
M1A is an SVT PMOS transistor and M2A is a depletion mode PMOS transistor
M1A is an SVT PMOS transistor and M2A is a LVT PMOS transistor
M1A is an LVT PMOS transistor and M2A is a natural PMOS transistor
M1A is an LVT PMOS transistor and M2A is a depletion mode PMOS transistor

M3A and M4A of the current mirror 110A are NMOS transistors in the example of FIG. 9 and, in some implementations, comprise SVT/LVT NMOS transistors. Implementing M3A and M4A as LVT transistors provides additional headroom so that the current source circuit 500 can operate with a lower VDD.

In the examples of FIGS. 1 and 9, because a natural transistor (M5 and M5A) in a degenerate configuration provides the initial bias current given its negative or near zero threshold voltage, a start-up circuit (such as that shown in FIGS. 1A and 1B) is not needed to ensure proper start-up operation of the current source circuits 100 and 500, respectively. That is, a start-up circuit is not required to bias the gates of any of the transistors during the initial power-up of the circuit. Further, the described current source circuits are capable of relatively fast start-up and fast recovery (from sudden changes in supply voltage) due to the use of MOS transistors which provide for smaller capacitance at nodes 130 and 130A thereby reducing delay. As the described current source circuits only have one operating point, the IBIAS current is able to recover quickly in the case of supply voltage transients. Further still, the current source circuits described herein can operate from a relatively low operating voltage as the operating voltage need only be greater than the sum of the threshold voltage of the diode-connected transistor M1 and the voltage across the initial bias generator 102. In some examples, the operating voltage can be as low as 1V.

FIG. 10 illustrates start-up and transient response of current source circuits described in FIGS. 2 and 9 compared to the current source circuits of FIGS. 1A and 1D. FIG. 10 illustrates a power-on event at time 0.0 and a momentary supply voltage transient from 720 and 730. Three current curves 705, 706, and 707 are shown. Current curve 705 represents the current Io produced by the current source of FIG. 1A. Current curve 706 represents the current produced by the current source of FIG. 1D. Current curve 707 represents the current produced by the current sources of FIGS. 2 and 6. As can be seen in FIG. 10, current curve 705 (current source of FIG. 1A) initially increases to a relatively high level 702 before eventually settling down to a steady state level as indicated by T1. Upon a sudden change in the supply voltage at 720, the current produced by the current source of FIG. 1A again increases substantially at 725 before settling down. Similarly, as the supply voltage at 730 returns to its nominal value (1.5 V in this example), the magnitude of the current produced by the current source of FIG. 1A increases to a relatively large negative value as indicated at 731 before settling back down in time T2 to its nominal current value.

As represented by the current curve 706 associated with the current source of FIG. 1D, the increase in the current at start-up and upon a sudden change in the supply voltage is much lower than for the current source of FIG. 1A. Upon the supply voltage increase at 720, the current produced by the current source of FIG. 1D increases to 723, and upon the supply voltage decrease at 730, the current produced by the current source of FIG. 1D increases to a negative peak value 734.

The start-up and supply voltage transient response of the current sources of FIGS. 2 and 9 are characterized by a much smaller increase (positive or negative) of the bias current. For example, 721 indicates the peak positive current upon a sudden increase in the supply voltage and 732 indicates the peak negative current upon a sudden decrease in the supply voltage. Peaks 721 and 732 are much smaller for the current source of FIGS. 2 and 9 than for either of the current sources of FIGS. 1A and 1D. The faster response time of the current sources of FIGS. 2 and 6 are attributed to the use of MOSFETs instead of BJTs. As such, the capacitance is relatively small at node 130 thereby reducing the delay. Further, the absence of any operating point other than the desired operating point (for the current sources of FIGS. 2 and 9) provides the circuits with the ability to recover quickly in case of supply transients.

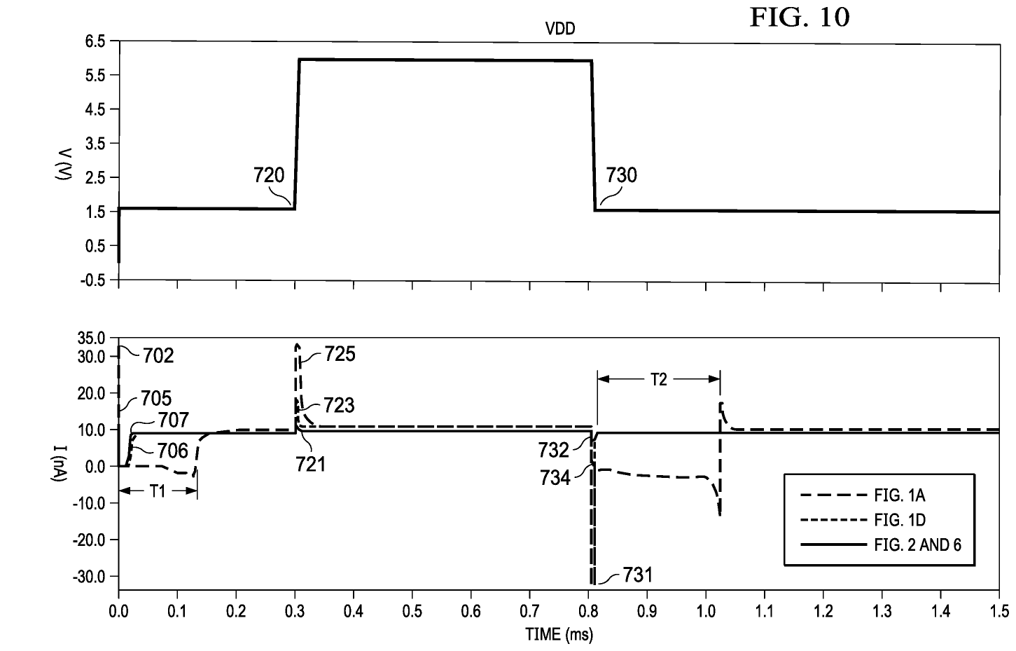

FIG. 11 shows an example of a system including the current source circuit 100 described above in FIG. 2. The gate and source of M3 from the current source circuit 100 is connected to the gate and source of transistors M6, M7, and M8 to form three current mirrors to mirror IBIAS. The mirrored currents are shown as IBIAS2, IBIAS3 and IBIAS4. IBIAS2 is provided to a sub-regulator circuit 802. IBIAS3 is provide to a bandgap voltage reference circuit 804. IBIAS4 is connected to a voltage comparator 806. The sub-regulator circuit 802 provides a voltage with relatively little voltage regulation for other circuits within the system. The bandgap voltage reference circuit 804 generates a process, voltage and temperature (PVT) compensated voltage to the voltage comparator 806 or other circuits within the system. The voltage comparator 806 compares a first voltage to a second voltage (e.g., the voltage from the bandgap voltage reference circuit 804) and generates a high or low output based on which of the first or second voltages is higher than the other. Each of the sub-regulator circuit 802, bandgap voltage reference circuit 804, and voltage comparator 806 receives a corresponding bias current generated based on the IBIAS current from current source circuit 100 for their operation.

The use of the disclosed current source circuit 100, 500 benefits systems such as that shown in FIG. 11 in that the current source circuit provides a reduced start-up time (time from power-on to producing bias current) and thus the system using such a current source circuit can start-up faster than if a slower start-up time current source circuit was used. Further, the resistance values for R1 and R2 are chosen such that M1 and M2 operate in the sub-threshold region. Also, IBIAS_1 is limited to some extent by the threshold voltage of M5. As a result, the current through R1 and R2 is relatively low and thus the quiescent current of the current source circuit 100, 500 is lower than for other current source circuits. Thus, for those systems using the current source circuit 100, 500 that are battery-powered, the relatively low quiescent current of the current source circuit beneficially extends battery life.

What is claimed is:

1. A current source circuit, comprising:
an initial bias generator;
a diode-connected first metal oxide semiconductor (MOS) transistor having a gate, a source, and a drain, the drain connected to the initial bias generator;
a second MOS transistor having a gate connected to the gate and drain of the diode-connected first MOS transistor;
a first resistor coupled between a source of the second MOS transistor and a ground node; and
a current mirror coupled to a drain of the second MOS transistor.

2. The current source circuit of claim 1, wherein the initial bias generator comprises a third MOS transistor and a resistive device connected to a source of the third MOS transistor.

3. The current source circuit of claim 2, wherein the third MOS transistor comprises a natural transistor.

4. The current source circuit of claim 2, wherein the third MOS transistor comprises a depletion mode transistor.

5. The current source circuit of claim 1, wherein the current mirror comprises a plurality of low threshold voltage p-channel MOS transistors.

6. The current source circuit of claim 1, wherein the current mirror comprises a plurality of low threshold voltage n-channel MOS transistors.

7. The current source circuit of claim 1, wherein:
the diode-connected first MOS transistor comprises a standard n-channel MOS transistor; and
the second MOS transistor comprises an n-channel natural MOS transistor.

8. The current source circuit of claim 1, wherein:
the diode-connected first MOS transistor comprises a standard n-channel MOS transistor; and
the second MOS transistor comprises an n-channel depletion mode MOS transistor or a low threshold voltage (LVT) MOS transistor.

9. The current source circuit of claim 1, wherein:
the diode-connected first MOS transistor comprises a low threshold voltage n-channel MOS transistor; and
the second MOS transistor comprises an n-channel natural MOS transistor.

10. The current source circuit of claim 1, wherein:
the diode-connected first MOS transistor comprises a low threshold voltage n-channel MOS transistor; and
the second MOS transistor comprises an n-channel depletion mode MOS transistor.

11. The current source circuit of claim 1, wherein:
the diode-connected first MOS transistor comprises a Standard threshold voltage n-channel MOS transistor; and
the second MOS transistor comprises a low threshold voltage n-channel MOS transistor.

12. The current source circuit of claim 1, wherein, for an inverse temperature dependence of a difference between threshold voltages of the diode-connected first MOS transistor and the second MOS transistor, a ratio of channel width to length for the second MOS transistor is larger than the ratio of channel width to length for the diode-connected first MOS transistor such that current through the current mirror is directly proportional to temperature.

13. The current source circuit of claim 1, wherein, for a direct temperature dependence of a difference between threshold voltages of the diode-connected first MOS transistor and the second MOS transistor, a ratio of channel width to length for the second MOS transistor is smaller than a ratio of channel width to length for the diode-connected first MOS transistor such that current through the current mirror is inversely proportional to temperature.

14. The current source circuit of claim 1, wherein:
for a direct temperature dependence of a difference between the threshold voltages of the diode-connected first MOS transistor and the second MOS transistor, a ratio of channel width to length for the second MOS transistor is smaller than a ratio of channel width to length for the diode-connected first MOS transistor such that current through the current mirror is approximately temperature invariant; and
for an inverse temperature dependence of a difference between the threshold voltages of the diode-connected first MOS transistor and the second MOS transistor, the ratio of channel width to length for the second MOS transistor is greater than a ratio of channel width to length for the diode-connected first MOS transistor such that current through the current mirror is approximately temperature invariant.

15. A current source circuit, comprising:
an initial bias generator;
a diode-connected first metal oxide semiconductor (MOS) transistor having a gate, a source, and a drain, the drain connected to the initial bias generator, and current from the initial bias generator to the diode-connected first MOS transistor to cause a voltage to be generated on the drain;
a second MOS transistor having a gate, a drain, and a source, the gate connected to the gate and drain of the diode-connected first MOS transistor, the second MOS transistor to generate a bias current between its drain and source responsive to the voltage on the drain of the diode-connector first MOS transistor;
a first resistor coupled between a source of the second MOS transistor and a ground node, the bias current to flow through the first resistor; and
a current mirror coupled to the drain of the second MOS transistor to mirror the bias current.

16. The current source circuit of claim 15, wherein the initial bias generator comprises a MOS transistor in a degenerate configuration, and the current mirror comprises a plurality of low threshold voltage MOS transistors.

17. The current source circuit of claim 15, wherein:
the diode-connected first MOS transistor comprises an n-channel MOS transistor; and
the second MOS transistor comprises one of an n-channel natural MOS transistor and an n-channel depletion mode MOS transistor.

18. The current source circuit of claim 15, wherein:
the diode-connected first MOS transistor comprises an p-channel MOS transistor; and
the second MOS transistor comprises one of an p-channel natural MOS transistor and an p-channel depletion mode MOS transistor.

19. The current source circuit of claim 15, wherein:
the diode-connected first MOS transistor comprises a low threshold voltage n-channel MOS transistor; and
the second MOS transistor comprises one of an n-channel natural MOS transistor or an n-channel depletion mode MOS transistor.

20. The current source circuit of claim 15, wherein:
the diode-connected first MOS transistor comprises a low threshold voltage p-channel MOS transistor; and
the second MOS transistor comprises one of an p-channel natural MOS transistor or an p-channel depletion mode MOS transistor.

21. The current source circuit of claim 15, wherein a ratio of channel width to length for the second MOS transistor is larger than a ratio of channel width to length for the diode-connected first MOS transistor such that current through the current mirror is directly proportional to temperature.

22. The current source circuit of claim 15, wherein a ratio of channel width to length for the second MOS transistor is smaller than a ratio of channel width to length for the diode-connected first MOS transistor such that current through the current mirror is inversely proportional to temperature.

23. A current source circuit, comprising:
a first metal oxide semiconductor field effect transistor (MOS) having a degenerate configuration;
a diode-connected MOS transistor having a gate, a source, and a drain, the drain connected to the first MOS transistor, and current from the first MOS transistor to the diode-connected MOS transistor to cause a voltage to be generated on the drain;
a second MOS transistor having a gate, a drain, and a source, the gate connected to the gate and drain of the diode-connected MOS transistor, the second MOS transistor to generate a bias current between its drain and source responsive to the voltage on the drain of the diode-connector first MOS transistor;
a first resistor coupled between a source of the second MOS transistor and a supply voltage node, the bias current to flow through the first resistor; and
a current mirror coupled to the drain of the second MOS transistor to mirror the bias current, the current mirror comprising a plurality of low or standard threshold voltage MOS transistors.
